(19) United States
(12) Patent Application Publication
(10) Pub. No.: US 2014/0019843 A1
(43) Pub. Date: Jan. 16, 2014

(54) GENERIC ANNOTATION FRAMEWORK FOR ANNOTATING DOCUMENTS

(71) Applicant: Olaf SCHMIDT, Walldorf (DE)

(72) Inventor: Olaf SCHMIDT, Walldorf (DE)

(21) Appl. No.: 13/546,047

(22) Filed: Jul. 11, 2012

(51) Int. Cl. G06F 17/20

(52) U.S. Cl. 715/230

(57) ABSTRACT

Various embodiments of systems and methods for annotating documents are described herein. In one aspect, the method includes identifying a type of a document to be annotated, selecting a mapping rule associated with the identified type of the document, and executing the selected mapping rule to determine a position of an annotation within the document. A user selection of the annotation is received. The selected annotation is stored along with the determined position. The annotation and its corresponding position are stored into a repository to enable linking the annotation to its corresponding position on a fly based upon a request. Based upon the request, the position is marked on the fly while displaying the document to show that the position includes the annotation.

### BACKGROUND

Annotation may be defined as a comment, a note, an explanation, a recommendation, or any other types of additional remarks which is attached to a document. An annotation is attached while reviewing or collaboratively creating a document. Usually, an annotation is attached to a specific position within the document. Therefore, an annotation becomes a part of the document and the document is modified. Different types of documents support different types of annotation. For example, some types of document support only a text annotation. If a user wants to explain something with a video annotation, the user may not be able to do so as the document does not support the video annotation. The user may be able to insert the video within the document but cannot annotate the document with the video, which may not be desirable. Some types of document do not even support the insertion of video within the document.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the folk detailed description taken in conjunction with the accompanying drawings.

FIG. 1 is a block diagram of a system including an annotation framework for annotating a document, according to an embodiment.

FIG. 2 illustrates a document repository including information related to documents registered with the annotation framework, according to an embodiment.

FIG. 3 illustrates a document type registry table including information related to various document types registered with the annotation framework, according to an embodiment.

FIG. 4 illustrates a mapping rule repository storing mapping rules corresponding to registered document types, according to an embodiment.

FIG. 5 illustrates a rule registry storing functions corresponding to each mapping rule, according to an embodiment.

FIG. 6 illustrates an annotation type registry including various document types and the corresponding types of annotation supported by those documents, according to an embodiment.

FIG. 7 illustrates the annotation type registry including various annotation types and their corresponding document types, according to another embodiment.

FIG. 8 illustrates a user interface adapted by a software vendor for utilizing annotation functionality of the annotation framework, according to an embodiment.

FIG. 9 illustrates an annotation repository storing annotations and information related to each annotation, according to an embodiment.

FIG. 10 illustrates a user registry table storing information including access right information of users registered with the annotation framework 110, according to an embodiment.

FIG. 11A illustrates the annotation framework displaying the document to the users based upon their respective access rights, according to an embodiment.

FIG. 11B illustrates an annotation being displayed when the user selects a marked position within the annotated document, according to an embodiment.

FIG. 12 is a block diagram of a search engine in communication with the annotation framework to perform search based upon various queries, according to an embodiment.

FIG. 13 illustrates a local environment coupled to the annotation framework through an application programming interface (API), according to an embodiment.

FIG. 14 is a flow chart illustrating the steps performed to externally link annotations to a document, according to an embodiment.

FIG. 15 is a flow chart illustrating the steps performed to display the externally annotated document to the users based upon their access rights, according to an embodiment.

FIG. 16 is a block diagram of an exemplary computer system, according to an embodiment.

### DETAILED DESCRIPTION

Embodiments of techniques for generic annotation framework to annotate documents are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

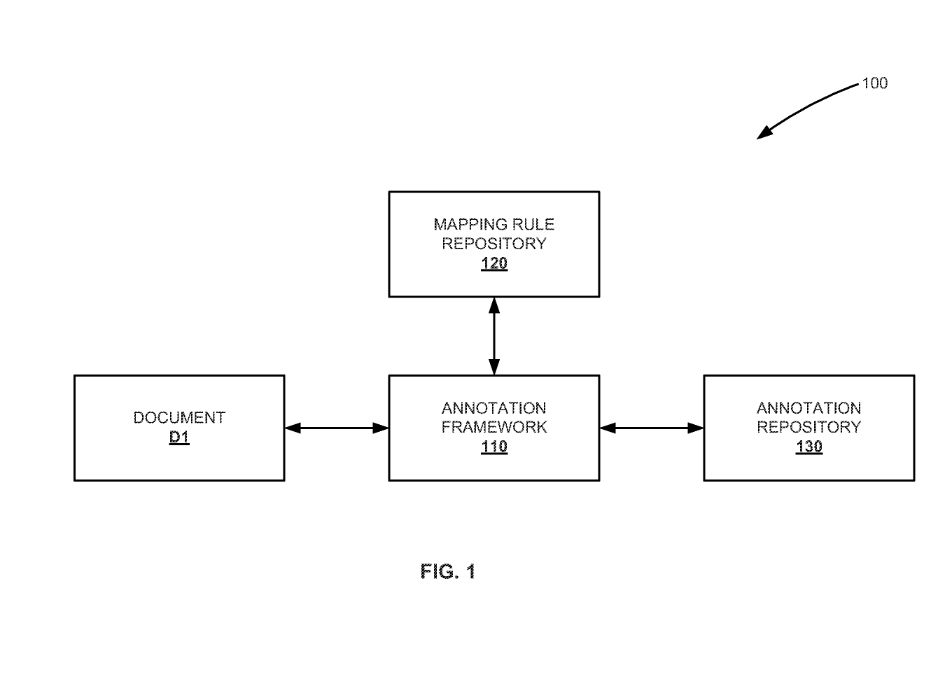

FIG. 1 illustrates a system 100 including an annotation framework 110 for annotating a document D1 according to one embodiment. The document D1 can be of any type such as text, audio, video, image, etc. The type of the document D1 is identified by the annotation framework 110. Based upon the type of the document D1, the annotation framework 110 selects a mapping rule for the document D1 from a mapping rule repository 120. The mapping rule is executed to determine a position within the document D1 where an annotation is to be externally linked. In one embodiment, the mapping rule determines the position based upon a location of a cursor. Once the position for the annotation is determined, the annotation framework 110 identifies the annotation selected by a user. The selected annotation is externally linked to the determined position. The external linking of annotation refers to storing the annotation along with its corresponding position in an annotation repository 130. The annotation and its corresponding position are read from the annotation repository 130 when requested. The read annotation is linked to its corresponding position on the fly. The position is marked on the fly to show that the position includes the externally linked annotation. In one embodiment, the position is marked with at least one of a symbol, an icon, and a highlighter. The marked position is displayed while displaying the document D1.

The document D1 may be one of the text document namely a Microsoft® Word, a Microsoft® Excel, and a pdf, etc. The document D1 can also be a video in any format such as a moving picture experts group (MPEG) format or a streaming video, etc.

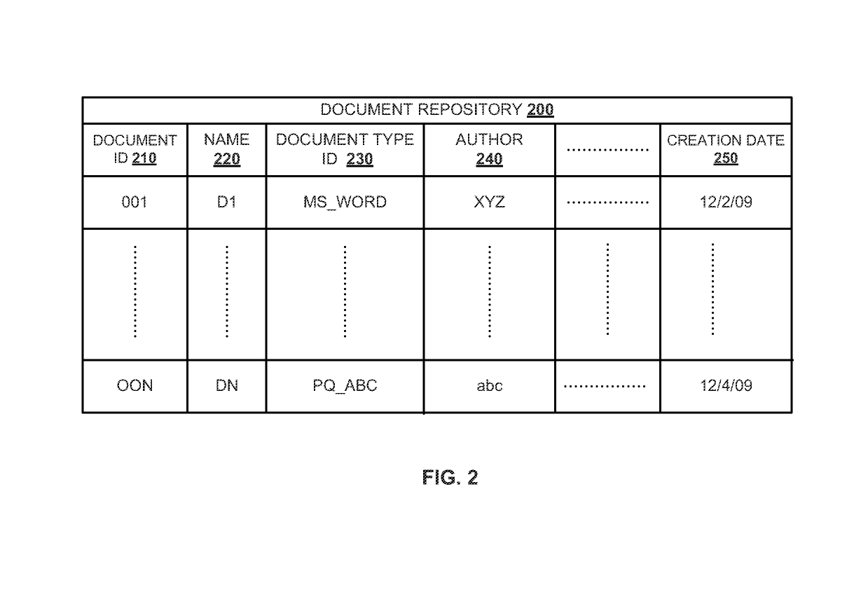

In one embodiment, the document D1 to be annotated is registered with the annotation framework 110. All the registered documents, e.g., the document D1 are stored in a document repository 200 (FIG. 2). The document repository 200 stores metadata or information related to the registered document D1. In one embodiment, the metadata includes at least one of a document identifier (ID) 210, a name 220, a document type ID 230, an author 240, and a creation date 250. The document ID 210 is a unique ID assigned to the registered document. For example, the ID ‘001’ is assigned to the document D1 and ID ‘00N’ is assigned to the document DN. The name 220 is a name of the document such as D1, DN, etc. The document type ID 230 is the ID to identify a document type or the type of the document. For example, the document type ID ‘MS_WORD’ identifies that the document D1 is a Microsoft® Word document. The author 240 is a name of a user who created the document and the creation date 250 is the date when the document was created. In one embodiment, the document repository 200 also includes a document type field (not shown) to indicate the type of the document.

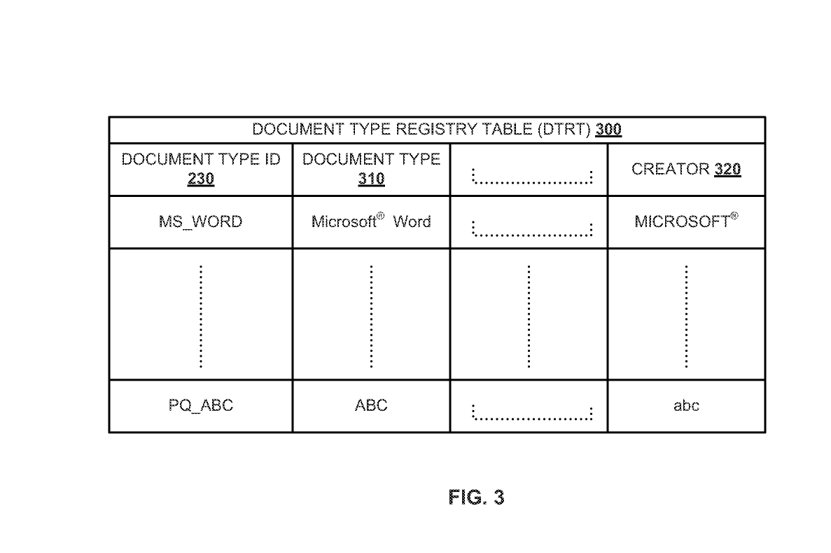

In one embodiment, various document types are registered with the annotation framework 110. The annotation framework 110 identifies or supports the document types that are registered with the annotation framework 110. For example, the annotation framework 110 identifies the document types such as text, spreadsheet, and pdf which are registered with the annotation framework 110. Each registered document type is assigned the unique document type ID 230. For example, the Microsoft® Word type document may be assigned the document type ID ‘MS-WORD.’ Similarly, the Microsoft® Excel type document may be assigned the document type ID ‘MS-EXCEL’ in one embodiment, the document type ID 230 may be a numeric value or an alphanumeric value. Information related to the registered document types is stored in a document type registry table (DTRT) 300 (FIG. 3). For example, the information related to the registered document type Microsoft® Word is stored in the DTRT 300.

In one embodiment, the DTRT 300 includes the document type ID 230, a type of document 310 indicating the type of the document associated with the document type ID 230. For example, the type of the document associated with the document type ID ‘MS _WORD’ is a ‘Microsoft® Word’ document. The DTRT 300 also stores other information related to the document type, e.g., a creator 320 of the document type, etc.

The annotation framework 110 identifies the type of the document D1 by reading at least one of the metadata 210-250 associated with the document D1 from the document repository 200. For example, the annotation framework 110 identifies the type of the document D1 by reading the document type ID 230 from the document repository 200. Based upon the document type ID 230, e,g., MS_WORD, the annotation framework 110 identifies the type of the document D1 from the DTRT 300. For example, based upon the document type ID ‘MS_WORD’ the annotation framework 110 identifies the type of the document as ‘Microsoft® Word document’ from the DTRT 300. In one embodiment, when the document repository 200 includes the document type field, the annotation framework 110 identifies the type of the document D1 by reading the document type field directly from the document repository 200. In one embodiment, the document type not registered with the annotation framework 110 may also be identified. For example, the annotation framework 110 may identity the document type or the type of the document by reading a signature such as a binary header of the document D1. In another embodiment, various other methods known in the art may be implemented by the annotation framework 110 to identify the type of the document D1.

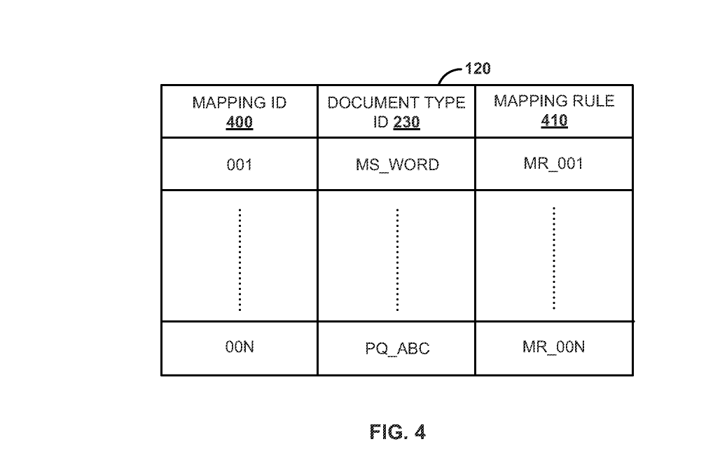

Once the type of the document D1 is identified, the annotation framework 110 identifies the mapping rule associated with the type of the document D1. The mapping rule is identified from the mapping rule repository (MRR) 120. In one embodiment, the MRR 120 is included within the annotation framework 110. In another embodiment, the MRR 120 is a separate entity positioned outside the annotation framework 110. In one embodiment, as illustrated in FIG. 4, the MRR 120 includes a mapping ID 400 which is a unique ID assigned to each mapping rule, the document type ID 230, and a mapping rule 410 associated with each document type ID 230. For example, the mapping rule MR_001 is associated with the document type ID ‘MS_WORD.’ The annotation framework 110 selects the mapping rule based upon the document type ID 230 of the document D1. For example, the annotation framework 110 selects the mapping rule MR_001 for the document D1 as its document type ID is ‘MS_WORD.” in one embodiment, one or more mapping rules may be associated with the document type ID 230. When the document type ID 230 is associated with more than one mapping rule 410, the annotation framework 110 selects the mapping rule based upon various criterions such as a type of annotation to be linked to the document, etc.

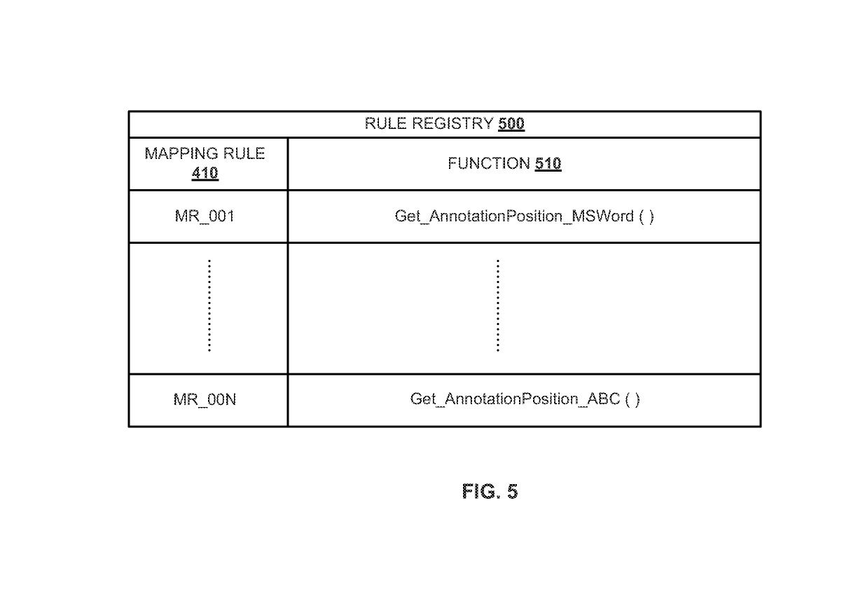

The selected mapping rule (MR_001) is executed to determine the position within the document D1 where the annotation is to be externally linked. In one embodiment, executing the mapping rule MR_001 comprises executing a function 510 (FIG. 5) associated with the mapping rule MR_001. The function associated with the mapping rule is called or executed to determine the position where the annotation is to be linked. FIG. 5 illustrates a rule registry 500 including the mapping rule 410 and their corresponding function 510. For example, the mapping rule MR_001 is associated with the function Get_AnnotationPosition_MSword ( ). The function Get_AnnotationPosition_MSword ( ) is executed to determine the position within the Microsoft® Word document D1 where the annotation is to be externally linked.

The function may require some input parameters to be executed. For example, the function Get_AnnotationPosition_MSword ( ) may require a location of a cursor within the document D1 to determine the position where the annotation is to be externally linked. The annotation framework 110 identities the location of the cursor within the document D1. The location of the cursor is passed to the function Get_AnnotationPosition_MSword ( ). The function Get_AnnotationPosition_MSword ( ) is executed based upon the cursor location to determine the position within the document where the annotation is to be externally linked. In one exemplarily embodiment, the function Get_AnnotationPosition_MSword ( ) may be as shown below:

Get_AnnotationPosition_MSword (CursorLocation)
{
Calculate position (page number, row number, column number) based
on cursor position on current page
Return calculated position;
}

The function Get_AnnotationPosition_MSword ( ) returns the position where the annotation is to be externally linked. For example, the function Get_AnnotationPosition_MSword ( ) may return the position (1, 1, 80). The position (1, 1, 80) indicates that the annotation is to be externally linked to row 1 and column 80 of page 1 of the document D1. In one embodiment, for the audio or the video type of document, the function returns the position in terms of a point of time within the audio or the video where the annotation is to be externally linked. For example, the function may return the position as 45 seconds from the beginning of the audio or the video where the annotation is to be externally linked.

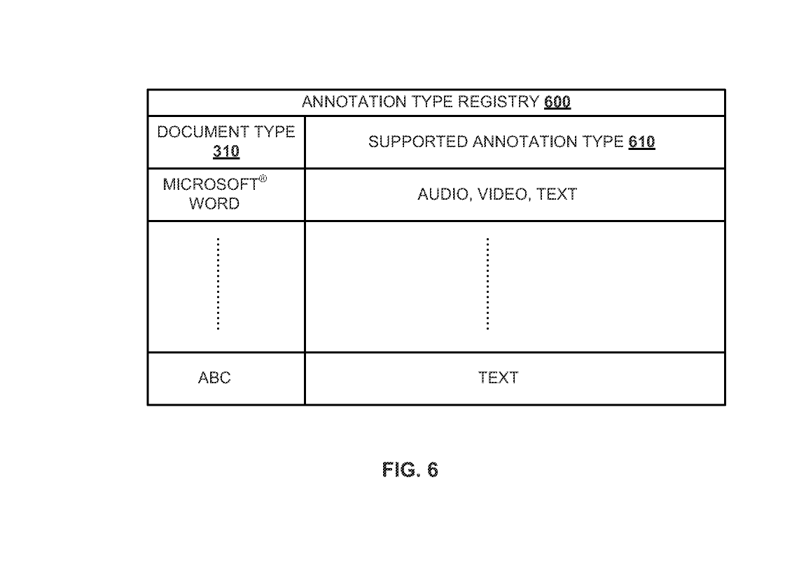

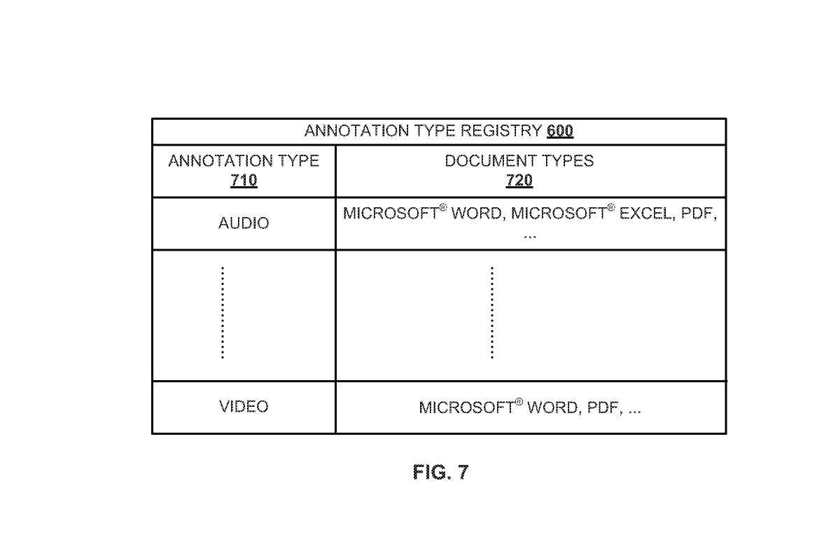

The annotation to be externally linked is one of the type namely a text, an audio, a video, an image, a calendar entry, a reminder, a power point presentation, a recorded meeting, etc. Each document type 310 supports one or more types of the annotation. FIG. 6 shows an annotation type registry 600 illustrating the document type 310 and an annotation type 610 supported by them. For example, the document type Microsoft® Word supports the text, the audio, and the video types of annotation and the document type ABC supports only text annotation. In another embodiment, the annotation type registry 600 may be configured as shown in FIG. 7. FIG. 7 illustrates the annotation type registry 600 including an annotation type 710 and one or more document types 720 supporting the respective annotation type. For example, the annotation type ‘video’ is supported by the document types Microsoft® Word and pdf.

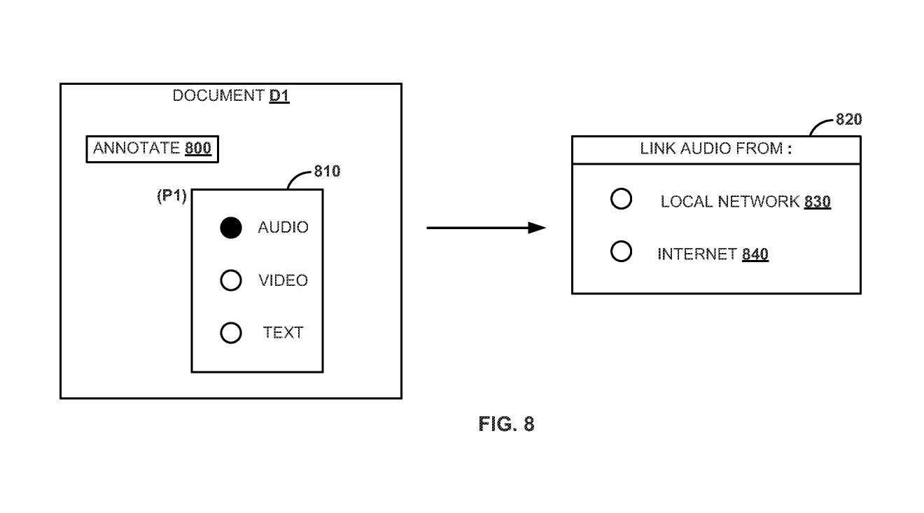

Various annotation types that can be supported or externally linked to the document D1 may be displayed to the user. In one embodiment, a software vendor can extend their application by incorporating a user interface (UI) or an application programming interface (API) to display various types of annotation which can be externally linked to the document D1. For example, the document D1 may be extended to include an icon “Annotate” 800 (FIG. 8). When the user selects the icon 800, the document D1 calls the annotation framework 110. The annotation framework 110 identifies the type of the document D1. Based upon the type of the document D1, the annotation framework 110 provides all annotation types which are supported by the type of the document D1.

In one embodiment, when a user selects a position P1 within the document D1 using an input means such as a mouse or a touchscreen, the annotation framework 110 provides all annotation types supported by the document D1. For example, for the Microsoft® Word document D1, the annotation framework 110 provides the annotation types namely the text, the audio, and the video, as illustrated in FIG. 8. A list 810 including all the supporting annotation types may be displayed to the user. In one embodiment, the list 810 is displayed adjacent to the position P1 where the annotation is to be externally linked. The users can select the type of the annotation of their choice. For example, the user may select the ‘audio.’

Once the type of the annotation or the annotation type is selected, UI 820 including various options for selecting the annotation of the type ‘audio’ is displayed. For example, the user may be provided the option to select the annotation of the type audio from a local network 830 (recorded meeting stored on a computer desktop) or from an internet 840. The selected annotation is identified by the annotation framework 110. The annotation framework 110 externally links the selected annotation to the position P1.

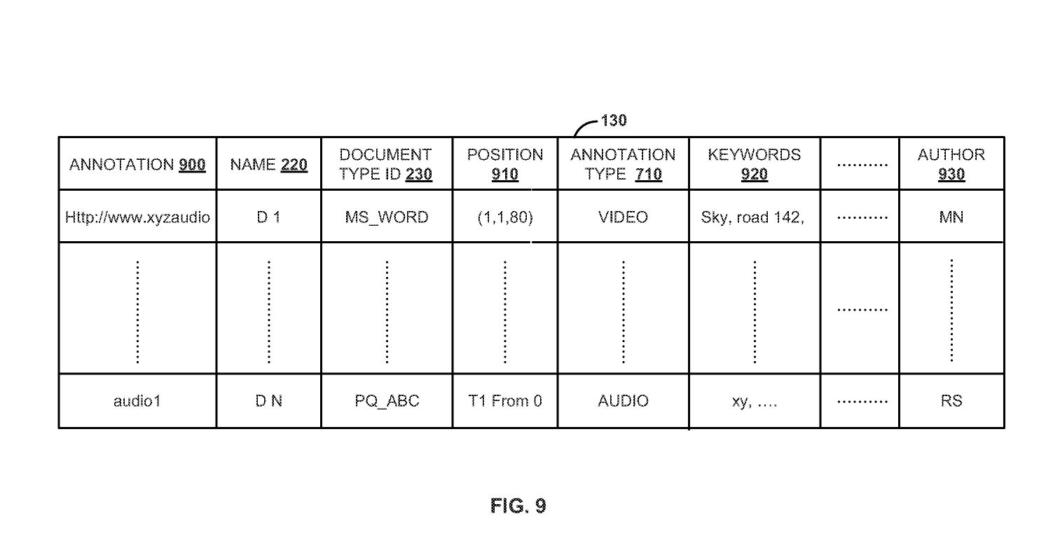

The external linking of annotation refers to storing the annotation and its corresponding position in the annotation repository 130. The annotation repository 130 includes various information or metadata related to the annotation. FIG. 9 illustrates the annotation repository 130 according to one embodiment. The annotation repository 130 includes an annotation 900. The annotation 900 indicates an actual annotation selected by the user. For example, if the user has selected the audio from the internet 840, the annotation 900 includes the direct link or address of the audio or a web page such as ‘http://www.xyzaudio.’ The name 220 indicating the name of the document, e.g., document D1 to which the annotation is externally linked. The document type ID 230 indicating the document type ID of the document. For example, the document type ID of the document D1 is ‘MS_WORD.’ A position 910 indicating the position such as P1 within the document where the annotation is externally linked. For example, the position 910 may be (1, 1, 80), i.e., page 1, row 1, and column 80, within the document D1 where the annotation ‘http://www.xyzaudio’ is externally linked. The annotation type 710 indicating the type of the annotation such as the audio, the video, the text, the image, etc. One or more keywords 920 related to the annotation and an author 930 indicating a name of the user who selected the annotation externally linked to the document.

In one embodiment, the author 930 is provided an option to enter the one or more keywords related to the annotation. For example, the author 930 may enter the keywords ‘sky,’ ‘road 142,’ etc., as the keywords for the annotation ‘http://www.xyzaudio’ externally linked to the row 1 and column 80 of page 1 of the document D1. The entered keywords are stored in the annotation repository 130.

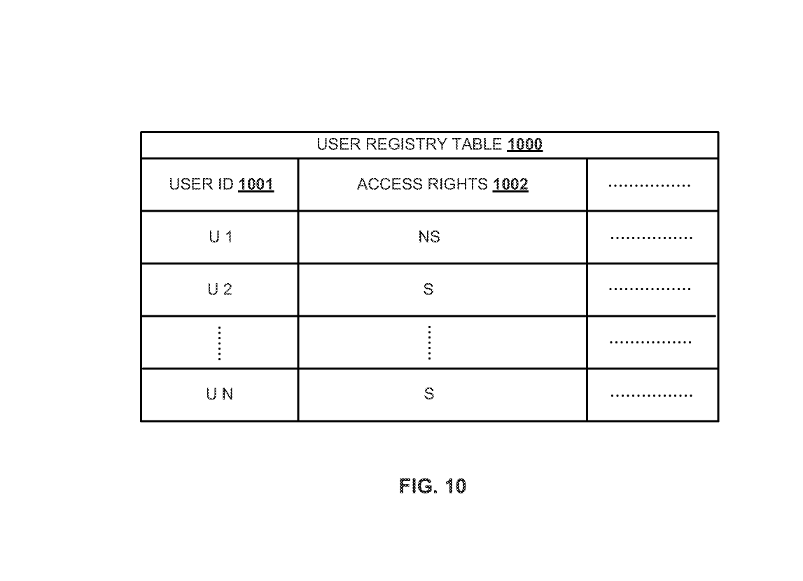

The annotation and its corresponding position may be read from the annotation repository 130 upon receiving a request for displaying the document. The request is received from a user (requester). In one embodiment, the user is registered with the annotation framework 110. Information related to the registered users are stored in a user registry 1000 (FIG. 10). For example, the user registry 1000 includes a user ID 1001 and an access right 1002 of the user, etc. The user ID 1001 indicates a unique ID assigned to the registered user and the access right 1002 indicates whether the user is allowed to view the annotation. When the user is allowed to view the annotation the access right may have some value such as ‘S’ or ‘1,’ In case the user is not allowed to view the annotation the access right may have the value ‘NS’ or ‘0.’ In one embodiment, there may be any suitable numerical or alphanumerical value that can be assigned to the access right to show whether the user is allowed to view the annotation or not. As shown in FIG. 10, the user is not allowed to view the annotation (access right=NS) while the user U2 is allowed to view the annotation (access right=S).

In one embodiment, the access right may include one or more values namely edit, read, write, and read only, etc. The annotation framework 110 reads the one or more values of the access right from the user registry 1000 and identifies whether the user is allowed to view the annotation or not. For example, the user with access right ‘read only’ may not be allowed to view the annotation whereas the user with the access right ‘edit’ may be allowed to view the annotation.

When the user is allowed to view the annotation, the annotation framework 110 displays the annotated document to the user. Typically, when the annotation framework 110 receives the request from the user, e.g., the user U2, the annotation framework 110 identifies the access right of the user U2. As the user U2 is allowed to view the annotation (access right=S), the annotation framework 110 reads the annotations externally linked to the document D1 and their corresponding position from the annotation repository 130. The annotations read from the annotation repository 130 are externally linked to their corresponding position within the document D1 on the fly. For example, the annotation ‘http://www.xyzaudio’ is externally linked to the position P1. The position, e.g., the position P1 is marked on the fly while displaying the document D1 to the user U2. The user U2 can identify the externally linked annotation by identifying the marked position P1. In one embodiment, the position P1 may be marked by an icon, a symbol, a highlighter, etc. When the user U2 selects the marked position P1, the annotation externally linked to the marked position P1 is displayed to the user. For example, when the user U2 selects the marked position P1, the audio from the link ‘http://www.xyzaudio’ is displayed to the user U2.

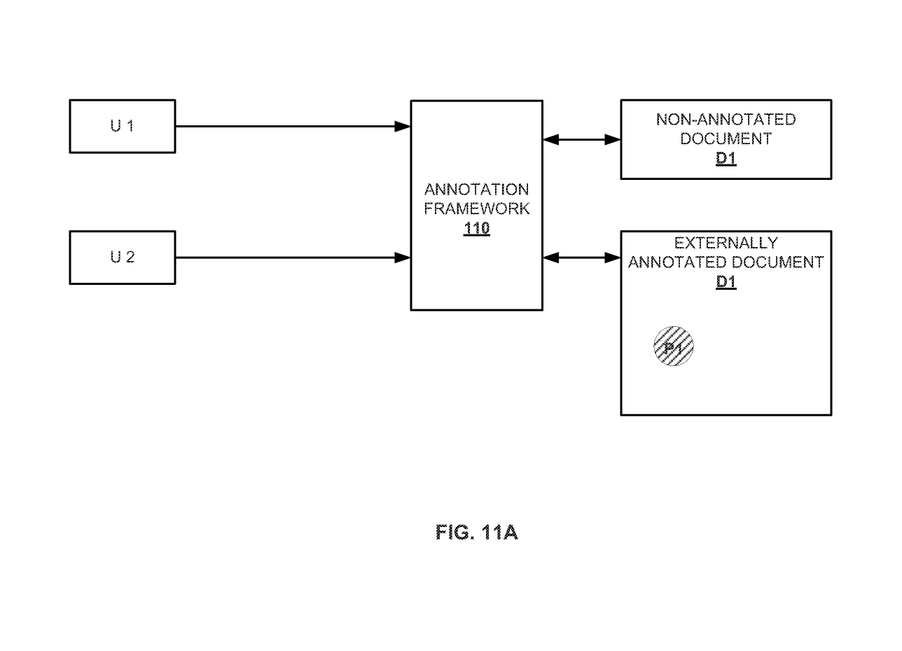

FIG. 11A illustrates displaying the document D1 to the users based upon their access rights. As shown, for the user U1 who is not allowed to view the annotation (access right=NS), the annotation framework 110 displays an original (non-annotated) document D1 whereas for the user 152 who is allowed to view the annotation (access right=S), the annotation framework 110 displays an externally annotated document D1. In one embodiment, the externally annotated document D1 may be generated by placing an annotation mask above the original document D1. The annotation mask identifies the annotation ‘http://www.xyzaudio’ externally lined to the document D1, links the identified annotation ‘http://www.xyzaudio’ to its corresponding position P1 within the document D1, and highlights the position P1 (shown as hashed circle) to generate the externally annotated document D1. The externally annotated document D1 is then displayed to the user U2.

In one embodiment, when the user selects the highlighted position P1, an annotation 1100 (FIG. 11B) linked to the position P1 is displayed. For example, the annotation 1100 being the audio ‘http://www.xyzaudio’ which is displayed to the user.

In one embodiment, when the user is allowed to view the annotation and the document includes the ‘reminder’ annotation, the reminder automatically pops-up while displaying the document to the user. In one embodiment, the user may require to enter a query to view the reminder. For example, the user may enter “show all reminders for <date>” to view all reminders created for a specific date. In one embodiment, the reminder is shown when the user selects the marked position externally linked to the reminder annotation.

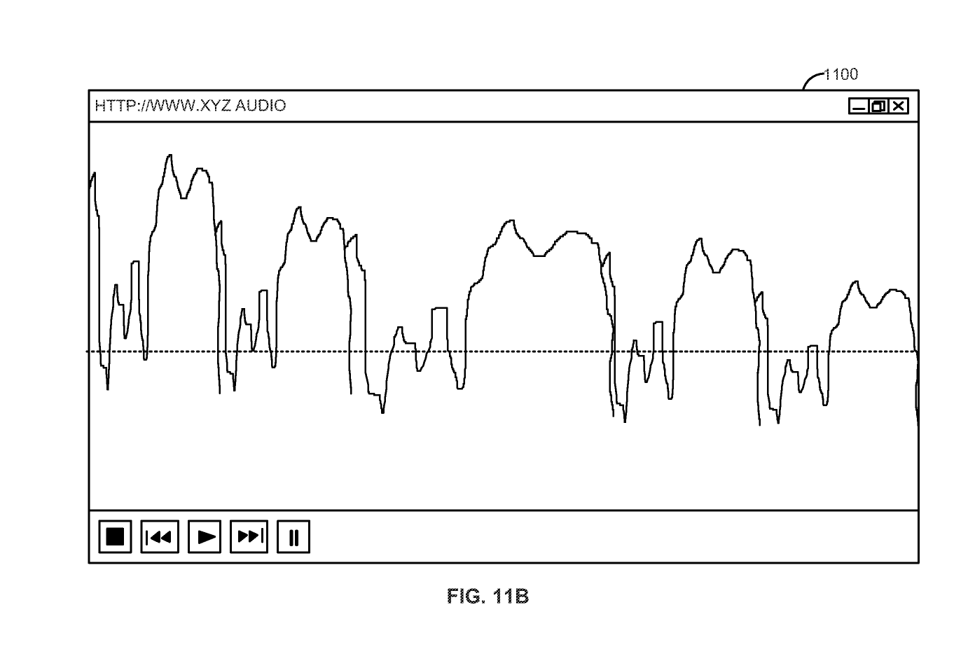

In one embodiment, as shown in FIG. 12, the annotation framework 110 is coupled to a search engine 1200. The search engine 1200 enables the user to search annotations based upon the one or more metadata related to the annotation. In one embodiment, the annotation repository 130 is cloud based and therefore, the annotations are on the cloud. The annotations stored on the cloud can be shared or searched from anywhere across the globe. The user can compose queries and the annotation framework 110 communicates with the search engine 1200 to provide a search result to the user based upon the search query. For example, few search queries may be as shown below:

Show all annotations linked to the document = <document name>;
Show all annotations linked to the document type = Microsoft® Word;
Show all annotations of the type = <audio>;
Show all annotations of the type <audio> AND author = <author name>;
Show all annotations created by the author = <author name> AND
created on <creation date>

In one embodiment, case of the audio or the video document, the annotation is searchable within a specific time interval within the audio or the video document. For example, the search query may be formed as “Show all annotations jailing in-between <time 1> to <time 2> of <name of the audio document>.” Time 1 has to be smaller than time 2. Similarly, the search query may be “show all annotations up to <time 3> from <name of the video document>,” to show all annotations from the beginning of the video up to time 3.

The queries may be entered in any suitable format or language, e.g., a structured query language (SQL). The format or the language is determined based upon the implementation or the API adapted by the software vendor. In one embodiment, the search engine 1200 is included within the annotation framework 110. In another embodiment, the search engine 1200 may be a separate entity positioned outside the annotation framework 110, as illustrated in FIG. 12.

In one embodiment, the query may be for searching a keyword associated with the annotations of the documents. For example, the query may be “Find ‘rood 142’ in all annotations of all documents.” Based upon the query, the annotation framework 110 searches the keyword, e.g., ‘road 142,’ within the annotation repository 130 to check if the keyword is associated with any annotation 900 (FIG. 9). If the keyword is not associated with any of the annotation 900, an error message may be displayed. In case the keyword is associated with one or more annotations, the annotations containing the keyword are displayed. For example, the annotation (http://www.xyzaudio) containing the keyword (road 142) is displayed.

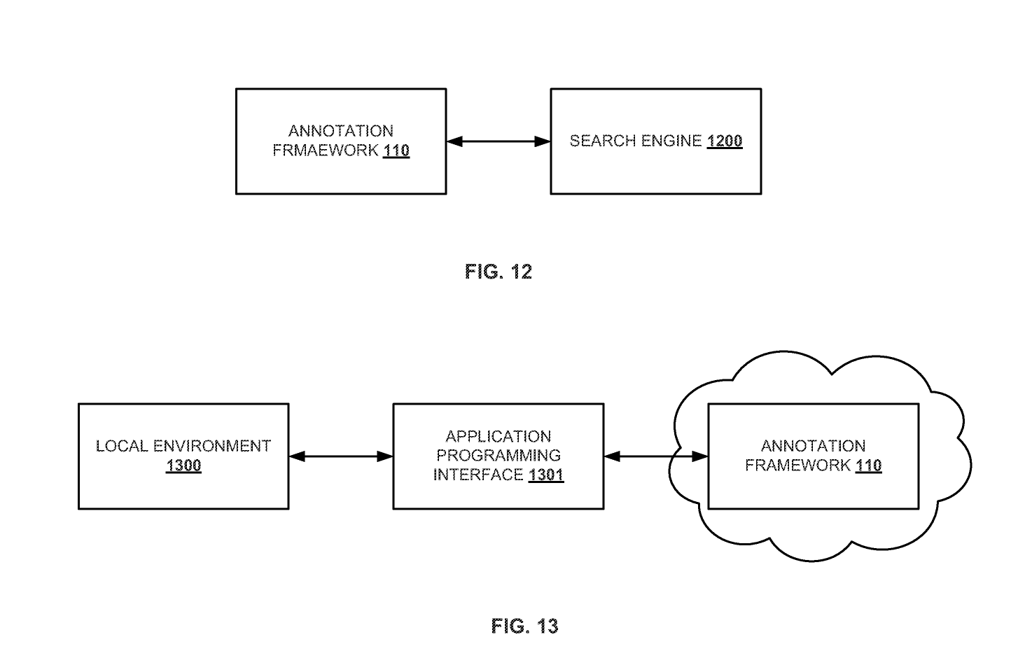

FIG. 13 illustrates a local environment 1300 connected to the annotation framework 110 through an extension or an API 1301. The local environment 1300 such as an enterprise network may be connected to the annotation framework 110 to utilize the annotation functionality like the search functionality provided by the annotation framework 110. In one embodiment, any software vendor from the local environment 1300 can extend their software application to incorporate the annotation functionality provided by the annotation framework 110. The software vendors can extend their application by getting connected to the annotation framework 110 through the API 1301. In one embodiment, the API 1301 may be provided or published by the annotation framework 110 provider. In another embodiment, the software vendor or application developer themselves develop the API 1301 to get connected to the annotation framework 110 to utilize the annotation functionality provided by the annotation framework 110.

In one embodiment, the API 1301 may be a representational state transfer (REST) API. The REST API 1301 allows to couple light devices such as a cell phone application to get connected to the annotation framework 110. In one embodiment, the API 1301 may be used for the annotation framework 110 extension. The annotation framework 110 may be extended to access an external content repository (not shown) positioned behind a firewall of an organization.

Some organizations may not prefer to keep their documents on the cloud in the document repository 200. The documents may be stored in their content repository (external content repository). The annotation framework 110 may access the external content repository through the API 1301. In one embodiment, the content repository is registered with the annotation framework 110. The annotation framework 110 can access the content repositories which are registered with the annotation framework 110. The annotation framework 110 can access the content repository through the API 1301 using a link or address of the content repository. In case of content repository documents, the document repository 200 includes a field to indicate whether the document is on the cloud (a local document) or the external document from the content repository. In one embodiment, all the content repositories which are registered with the annotation framework 110 may be maintained in a separate table (not shown). In one embodiment, the annotation repository 130 also includes a field to indicate whether the annotation is linked to the external content repository document or to the local document on the cloud.

In one embodiment, the annotation framework 110 maintains a log file including information related to each annotation, e.g., the annotation, the user who created the annotation, the user who modified the annotation, when the annotation was modified, etc. Therefore, all versioning related to the annotation can be tracked.

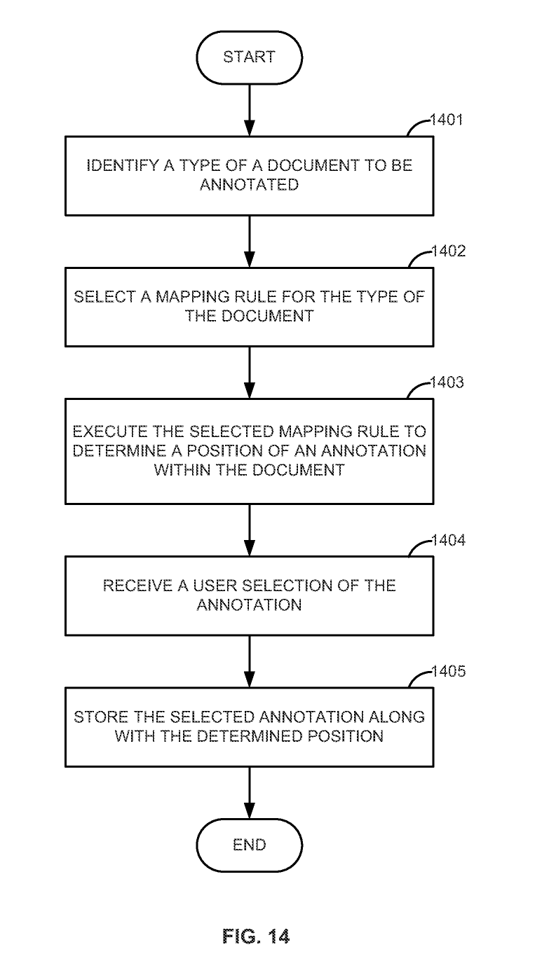

FIG. 14 is a flowchart illustrating a method for externally linking the annotation to the document D1, according to one embodiment. The document D1 to be externally annotated is registered with the annotation framework 110. The annotation framework 110 identifies the type of the document D1 at step 1401. The type of the document may be one of the text, the audio, the video, and the image, etc. The type of the document may be identified from the document repository 200. Each document type is associated with the mapping rule. Based upon the type of the document D1, the annotation framework 110 selects the mapping rule for the document D1 from the MRR 120 at step 1402. The selected mapping rule is executed to determine the position of the annotation within the document D1 at step 1403. In one embodiment, the user selects the type of the annotation to be linked to the determined position. The annotation may be of the types namely the text, the audio, the video, the power point presentation, the recorded meetings, the reminder, etc. Typically, the user is provided all types of annotation supported by the document D1 for selection. Once the user selects the annotation type, the user is given an option to select the annotation of the identified type. The annotation framework 110 receives the user selection of the annotation at step 1404. The selected annotation is stored along with the determined position within the annotation repository 130 at step 1405. The stored annotation and its corresponding position are read from the annotation repository 130 when requested. Based upon the request, the annotation is linked to its corresponding position on the fly. The position is marked on the fly to show that the position includes the externally linked annotation.

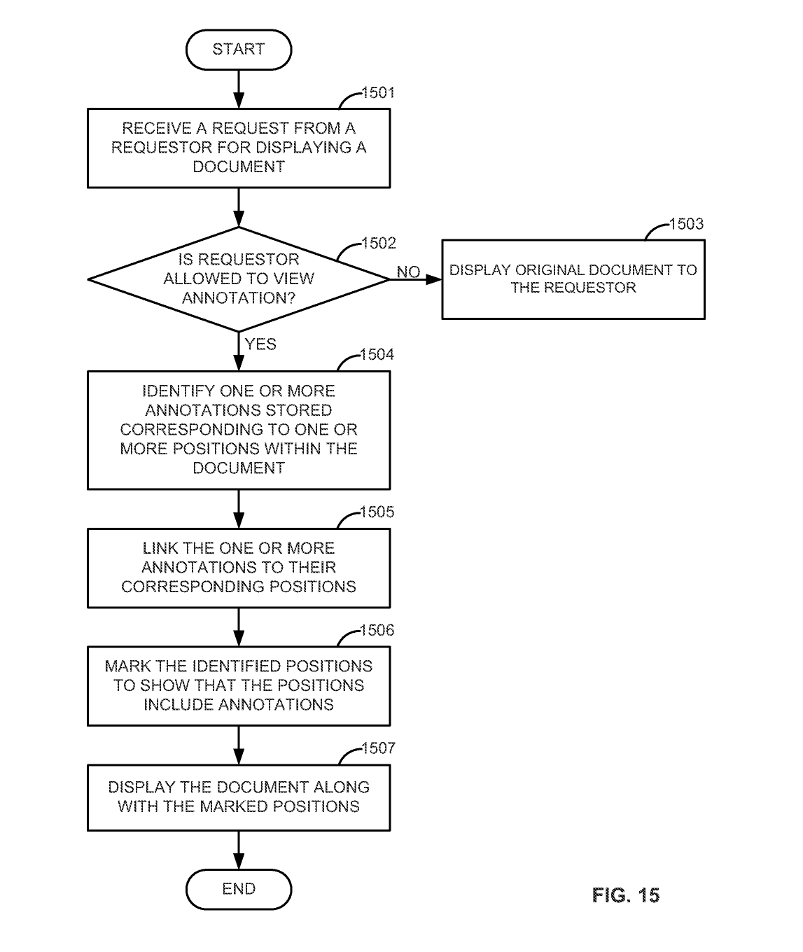

FIG. 15 is a flowchart illustrating a method for displaying externally annotated document D1 to the user or requestor based upon their access rights, according to one embodiment. The user request for displaying the document D1. The annotation framework 110 receives the request from the user at step 1501. Once the request is received, the annotation framework 110 determines whether the user is allowed to view the annotation at step 1502. When the user is not allowed to view the annotation (step 1502: NO), the original document D1 is displayed to the user without annotation at step 1503. In case the user is allowed to view the annotation step 1502: YES), the annotation framework 110 identifies the one or more annotations stored corresponding to the one or more positions within the document D1 at step 1504. The annotations are linked to their respective position within the document D1 at step 1505. The annotation framework 110 marks the identified positions to show that the positions include the annotation at step 1506. In one embodiment, the identified position is marked with at least one of the symbol, the icon, and the highlighter. The document D1 with marked position is displayed to the user at step 1507.

Embodiments described above provide a generic framework for annotating any type of document such as a text document, an audio, a video, an image, etc., with any types of annotation, e.g., a text, an audio, a video, an image, a presentation (.ppt), a reminder, etc. The flexibility to annotate any type of document with any type of annotation enables users to make remarks in a better fashion. The concept of the reminder annotation further enhances the annotation feature. The annotation is externally linked to an original document and is not a part of the original document. The original document remains untouched and unmodified. An annotation mask is placed above the original document on a fly to display the annotations when requested. The annotation mask is applied upon the original document to display the annotations only to the users who are eligible to view the annotations. Positions within the document which are externally linked to the annotation are marked on the fly to show that the positions include the externally linked annotation. The positions may be marked with a symbol, an icon, or a highlighter. The framework is cloud-based which allows the users to share or search annotations from different geographic locations. Annotations can be searched based upon, e.g., a creation date of the annotation, a name of an author who created the annotation, the name of the author who modified the annotation, one or more keywords associated with the annotation, a specified region within the image, or a specified time interval within the video, etc. Any software vendor can get connected to the framework via an extendible feature, e.g., an application programming interface (API) to utilize the annotation features provided by the framework. New document type or new annotation type may be easily incorporated. Therefore, the annotation framework is user friendly, flexible, and extensible.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of or in combination with machine readable software instructions.

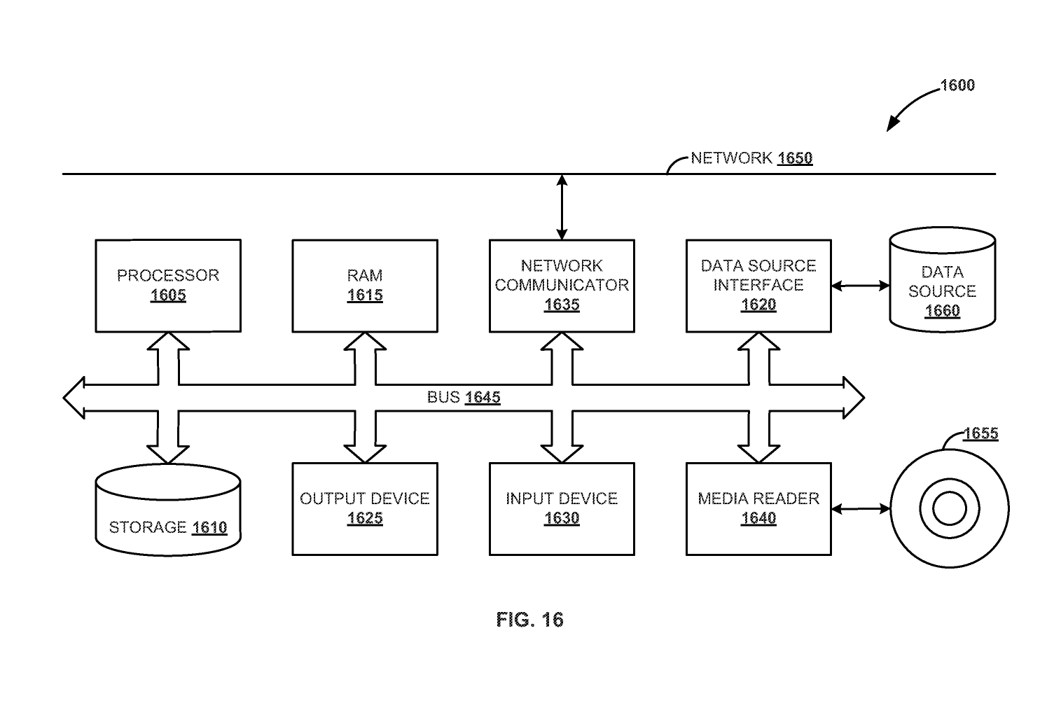

FIG. 16 is a block diagram of an exemplary computer system 1600. The computer system 1600 includes a processor 1605 that executes software instructions or code stored on a computer readable storage medium 1655 to perform the above-illustrated methods. The computer system 1600 includes a media reader 1630 to read the instructions from the computer readable storage medium 1655 and store the instructions in storage 1610 or in random access memory (RAM) 1615. The storage 1610 provides a large space for keeping static data where at least some instructions could be stored for later execution. The stored instructions may be further compiled to generate other representations of the instructions and dynamically stored in the RAM 1615. The processor 1605 reads instructions from the RAM 1615 and performs actions as instructed. According to one embodiment, the computer system 1600 further includes an output device 1625 (e.g., a display) to provide at least some of the results of the execution as output including, but not limited to, visual information to users and an input device 1620 to provide a user or another device with means for entering data and/or otherwise interact with the computer system 1600. Each of these output devices 1625 and input devices 1620 could be joined by one or more additional peripherals to further expand the capabilities of the computer system 1600. A network communicator 1635 may be provided to connect the computer system 1600 to a network 1650 and in turn to other devices connected to the network 1650 including other clients, servers, data stores, and interfaces, for instance. The modules of the computer system 1600 are interconnected via a bus 1645. Computer system 1600 includes a data source interface ID1 to access data source 1660. The data source 1660 can be accessed via one or more abstraction layers implemented in hardware or software. For example, the data source 1660 may be accessed by network 1650. In some embodiments the data source 1660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system, e.g., an ERP system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. An article of manufacture including a non-transitory computer readable storage medium to tangibly store instructions, which when executed by one or more computers in a network of computers causes performance of operations comprising:
identifying a type of a document to be annotated;
selecting a mapping rule associated with the type of the document;
executing the selected mapping rule to determine a position of an annotation within the document;
receiving a user selection of the annotation; and
storing the selected annotation along with the determined position it a repository.

2. The article of manufacture of claim 1, wherein the type of the document comprises one of a text, an audio, a video, and an image.

3. The article of manufacture of claim 2, wherein when the type of the document is one of the audio and the video, the position within the document refers to a point of time within the audio or the video.

4. The article of manufacture of claim 1, wherein the mapping rule determines the position based upon a location of cursor within the document.

5. The article of manufacture of claim 1 further comprising instructions which when executed cause the one or more computers to perform the operations comprising:
receiving a request for providing one or m-ore: types of annotation supported by the document; and
based upon the request, providing the one or more types of annotation supported by the document.

6. The article of manufacture of claim 5 further comprising instructions which when executed cause the one or more computers to perform the operations comprising:
receiving the user selection of a type of annotation from the one or more types of annotation supported by the document; and
based upon the user selection, identifying the type of the annotation to be stored corresponding to the determined position.

7. The article of manufacture of claim 1 further comprising instructions which when executed cause the one or more computers to:
store metadata related to the annotation in a cloud based repository, wherein the metadata related to the annotation comprises at least one of:
a name of the document;
the type of the document;
the type of the annotation comprising one of a text, an audio, a video, an image, a power point presentation, and a reminder;
the position of annotation within the document, wherein when the document is an audio or a video, the position of annotation within the document is a point of time within the audio or the video;
a creation date of the annotation;
a name of an author who selected the annotation; and
one or more keywords associated with the annotation.

8. The article of manufacture of claim 7 further comprising instructions which when executed cause the one or more computers to perform the operations comprising:
receiving a keyword to be searched in one or more annotations of one or more documents of various types;
determining whether the keyword is associated with at least one of the one or more annotations of the one or more documents;
when the keyword is not associated with any of the annotations, displaying an error message; and
when the keyword is associated with the one or more annotations, displaying the one or more annotations of the one or more documents.

9. The article of manufacture of claim 1 further comprising instructions which when executed cause the one or more computers to perform the operations comprising:
receiving a request from a requestor for displaying the document; and
based upon access rights of the requestor, performing the operations comprising:
identifying one or more annotations stored corresponding to one or more positions within the document;
linking the one or more annotations to their corresponding position within the document;
marking the one or more positions within the document with at least one of an icon, a symbol, and a highlighter to show that the one or more positions include the annotation; and
displaying the document along with the marked positions.

10. The article of manufacture of claim 9 further comprising instructions which when executed cause the one or more computers to perform the operations comprising:
receiving a user selection of the marked position; and
displaying an annotation stored corresponding to the selected marked position.

11. A method for annotating a document implemented on a network of one or more computers, the method comprising:
identifying a type of the document to be annotated;
selecting a mapping rule associated with the type of the document;
executing the selected mapping rule to determine a position of an annotation within the document;
receiving a user selection of the annotation; and
storing the selected annotation along with the determined position in a repository.

12. The method of claim 11 further comprising:
receiving a request for providing one or more types of annotation supported by the document;
based upon the request, providing the one or more types of annotation supported by the document;
receiving the user selection of a type of annotation from the one or more types of annotation supported by the document; and
based upon the user selection, identifying the type of the annotation to be stored corresponding to the determined position.

13. The method of claim 11 further comprising:
receiving a keyword to be searched in one or more annotations of one or more documents of various types;
determining whether the keyword is associated with at least one of the one or more annotations of the one or more documents;
when the keyword is not associated with any of the annotations, displaying an error message; and
when the keyword is associated with the one or more annotations, displaying the one or more annotations of the one or more documents.

14. The method of claim 11 further comprising:
receiving a request from a requestor for displaying the document; and
based upon access rights of the requestor, performing the operations comprising:
identifying one or more annotations stored corresponding to one or more positions within the document;
linking the one or more annotations to their corresponding position within the document;
marking the one or more positions within the document with at least one of an icon, a symbol, and a highlighter to show that the one or more positions include the annotation; and
displaying the document along with the marked positions.

15. A computer system for annotating a document comprising:
a memory to store program code; and
a processor communicatively coupled to the memory, the processor configured to execute the program code to cause one or more computers in a network of computers to:
identify a type of the document to be annotated;
select a mapping rule associated with the type of the document;
execute the selected mapping rule to determine a position of an annotation within the document;
receive a user selection of the annotation; and
store the selected annotation along with the determined position in a repository.

16. The computer system of claim 15, wherein the processor is further configured to perform the operations comprising:
receiving a request for providing one or more types of annotation supported by the document;
based upon the request, providing the one or more types of annotation supported by the document.

17. The computer system of claim 16, wherein the processor is further configured to perform the operations comprising:
receiving the user selection of a type of annotation from the one or more types of annotation supported by the document; and
based upon the user selection, identifying the type of the annotation to be stored corresponding to the determined position.

18. The computer system of claim 15, wherein the processor is further configured to perform the operations comprising:
receiving a keyword to be searched in one or more annotations of one or more documents of various types;
determining whether the keyword is associated with at least one of the one or more annotations of the one or more documents;
when the keyword is not associated with any of the annotations, displaying an error message; and
when the keyword is associated with the one or more annotations, displaying the one or more annotations of the one or more documents.

19. The computer system of claim 15, wherein the processor is further configured to perform the operations comprising:
receiving a request from a requestor for displaying the document; and
based upon access rights of the requestor, performing the operations comprising:
identifying one or more annotations stored corresponding to me or more positions within the document;
linking the one or more annotations to their corresponding position within the document;
marking the one or more positions within the document with at least one of an icon, a symbol, and a highlighter to show that the one or more positions include the annotation; and
displaying the document mg with the marked positions.

20. The computer system of claim 19, wherein the processor is further configured to perform the operations comprising:
receiving a user selection of the marked position; and
displaying an annotation stored corresponding to the selected marked position.
